(19) United States
(12) Patent Application Publication
(10) Pub. No.: US 2024/0218207 A1
(43) Pub. Date: Jul. 4, 2024

(54) MIXTURE WITH WAXING AND POLISHING EFFECT

(71) Applicant: TSUNG HAN TSAI, Changhua (TW)

(72) Inventor: TSUNG HAN TSAI, Changhua (TW)

(21) Appl. No.: 18/397,609

(22) Filed: Dec. 27, 2023

(30) Foreign Application Priority Data
Jan. 3, 2023 (TW) 112100094

(51) Int. Cl. C09G 1/02; C09G 1/12

(52) U.S. Cl. CPC C09G 1/02; C09G 1/12

(57) ABSTRACT

A mixture with a waxing and polishing effect, mainly composed of the following components: 15-30% by weight of wax; 25-45% by weight of colloidal resin; 2-5% by weight of glycerin; 15-30% by weight % of abrasives. The mixture can be fixed on a sponge, foam or a fiber cloth to remove industrial dust, sand, solid particles, asphalt, spray paint smoke and other attachments on the paint of cars, motorcycles or bicycles, glass or metal surfaces, and can be It has a waxing and polishing effect on the car, motorcycle or bicycle paint, glass or metal surface (forming a bright and smooth surface).

### BACKGROUND OF THE DISCLOSURE

### 1. Field of the Disclosure

The present invention relates generally to a cleaning product, and more particularly to a mixture with a waxing and polishing effect, which is capable of cleaning a surface of an article and forming a bright and smooth surface.

### 2. Description of the Prior Art

Vehicles, such as cars, motorcycles, and bicycles, usually are parked at outdoor, and particles, such as industrial dust, sand, solid particles, asphalt, spray paint smoke, are attached on surfaces of the vehicles. Such particles are not easy to be removed by water only. The commonest cleaning way is mixing water with soap or detergent, spraying it on the surface, and wiping it by a fiber cloth or sponge or foam. However, the effect of cleaning is limited, and even it might damage the surface of the article. A powerful way of cleaning is polishing the surface with a sandpaper. It will remove all the particles on the surface, but it badly damages the surface at the same time. Recently, such particles on a surface are removed by crude wax. Crude wax is better than the sandpaper, but it still damaged the surface and needs a longer working time with harder operation.

Recently, a cleaning clay is presented in the market. The clay may stick the particles on the surface. It has a shorter working time than the crude wax. However, it needs to changes the portions contact the surface every time it has sticked the particles, and the cleaning effect is also limited. Most of all, the clay may only use for a short time, and it has to be through away if all portions are used to stick particles. In addition, it still has a risk of damage the surface.

### SUMMARY OF THE DISCLOSURE

In light of the above reasons, the primary objective of the present invention is to provide a mixture with a waxing and polishing effect, which provides an easy way of cleaning a surface of an article and forms a bright and smooth surface.

In order to fix the problem as described above the present invention provides a mixture with a waxing and polishing effect, comprises:
A) 15-30% by weight of wax;
B) 25-45% by weight of colloidal resin;
C) 2-5% by weight of glycerin; and
D) 15-30% by weight % of abrasives.

In an embodiment, the abrasives are selected from the group consisting of aluminium oxide, silicon carbide, garnet, calcium carbonate, or alumina.

In an embodiment, the abrasives have different crystalized shapes.

In an embodiment, the abrasives have an average diameter less than 0.001 mm.

In an embodiment, the mixture is coated on a sponge or a foam.

In an embodiment, the mixture is coated on a fiber cloth.

In an embodiment, the mixture is coated on a paper.

In an embodiment, the mixture 2-5% by weight of the glycerin is replaced by dipropylene glycol or propylene glycol. is coated on a glove.

According to the objective, function and structure, hereunder is/are the preferred embodiment(s), accomplished with drawings, to describe the present invention.

### BRIEF DESCRIPTION OF THE DRAWINGS

FIG. 1 is a perspective of a preferred embodiment of the present invention, showing the mixture coated on the sponge;

FIG. 2 is an enlarged view of the preferred embodiment of the present invention, showing how the mixture cleaning the surface;

FIG. 3 is a perspective view of the preferred embodiment of the present invention, showing the mixture coated on the fiber cloth; and

FIG. 4 is a perspective view of the preferred embodiment of the present invention, showing the mixture coated on the glove.

### DETAILED DESCRIPTION

A mixture with a waxing and polishing effect of a preferred embodiment of the present invention comprises the following components:
A) 15-30% by weight of wax 11;
B) 25-45% by weight of colloidal resin 12;
C) 2-5% by weight of glycerin 13; and
D) 15-30% by weight % of abrasives 14.

The wax 11 has a melting temperature between 47° C. and 66° C. with a low stickiness, high wear-resisting and lipophilicity, so it will evenly distribute in oil (glycerin 13 in the present embodiment). The wax 11 may provide oil with high sticky strength, moisture-proof, anti-corrosion, glazing, insulation, and rust-proof. It further provides the functions of preventing cracking and bubbles.

The resin 12 is a solid, soft and sticky material, such as silicone, medical white glue or melt glue. It provides the mixture of the present embodiment with predetermined stickiness, elasticity and cohesion. Natural resin is the preferred choice of the resin 12 to protect the environment.

The glycerin 13 may release the wax 11 evenly to the surface of the article to provide the functions of glazing, water repellency and lubrication. When the glycerin 13 is mixed with water, it has hygroscopicity. In another embodiment, 2-5% by weight of glycerin 13 is replaced by dipropylene glycol or propylene glycol.

The abrasives 14 may be aluminium oxide, silicon carbide, garnet, calcium carbonate, or alumina. The abrasives 14 have various crystalized shapes and an average diameter less than 0.001 mm.

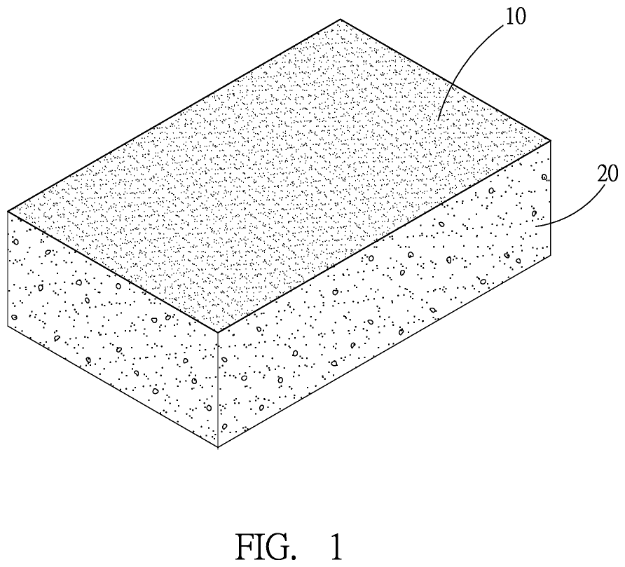

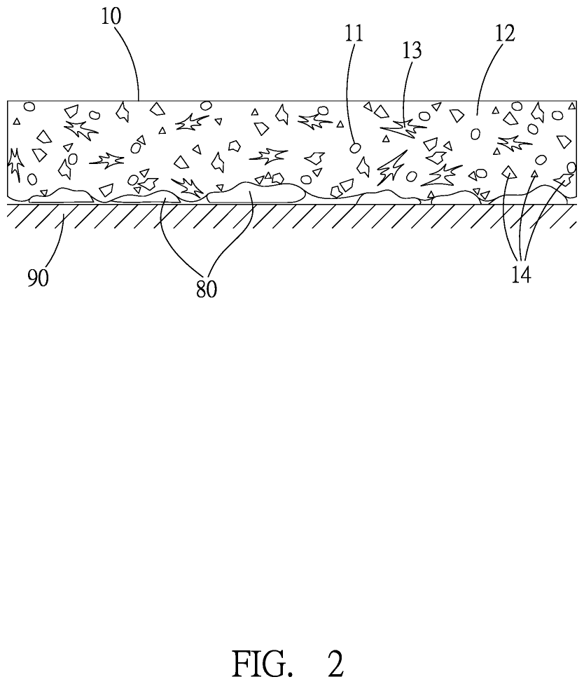

As shown in FIG. 1 and FIG. 2, the mixture 10 of the preferred embodiment is coated on a sponge 20. The sponge 20 provides function of easy to hold and operate, absorbing and evening pressure.

When use the mixture 10 to clean a surface of an article 90, such as painted, glass, or metal surface of car, motorcycle and bicycle, the resin 10 of the mixture may wrap up and stick particles 80, such as industrial particles, sands, solid particles, bitumen, and painting particles, attached on the surface, and then the abrasives 14 may “shovel” the particles 80 up from the surface to remove the particles 80 from the surface of the article 90. The mixture 10 of the embodiment provides an easy way to remove the particles 80 on the surface of the article 90 with less exertion and short time.

In addition, the glycerin 13 in the mixture 10 may help to release the wax 11 evenly and slowly. Therefore, the wax 11 may be coated on the surface after the particles 80 are removed to provide a bright and smooth surface.

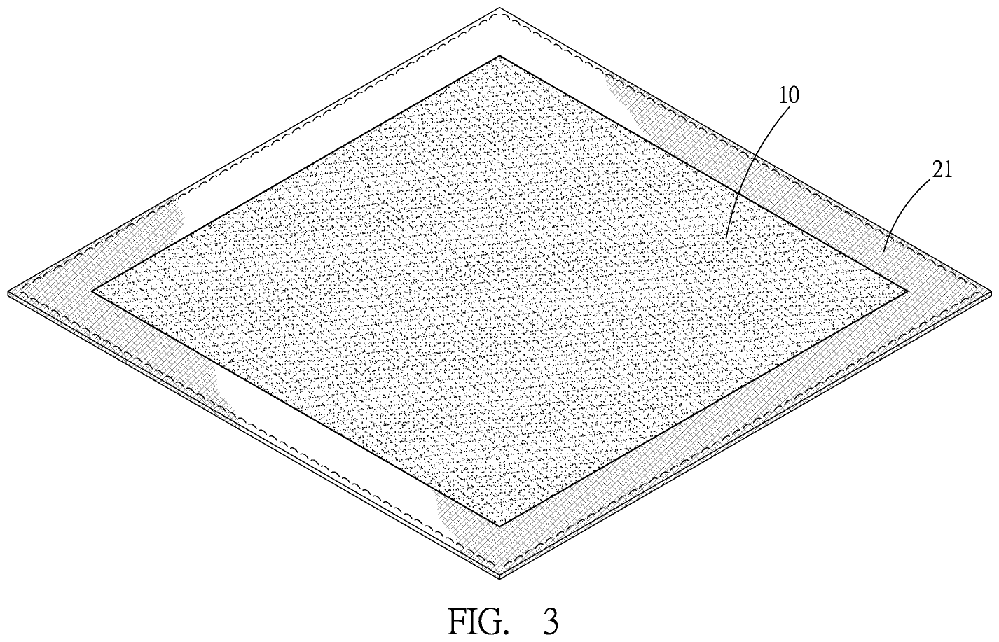

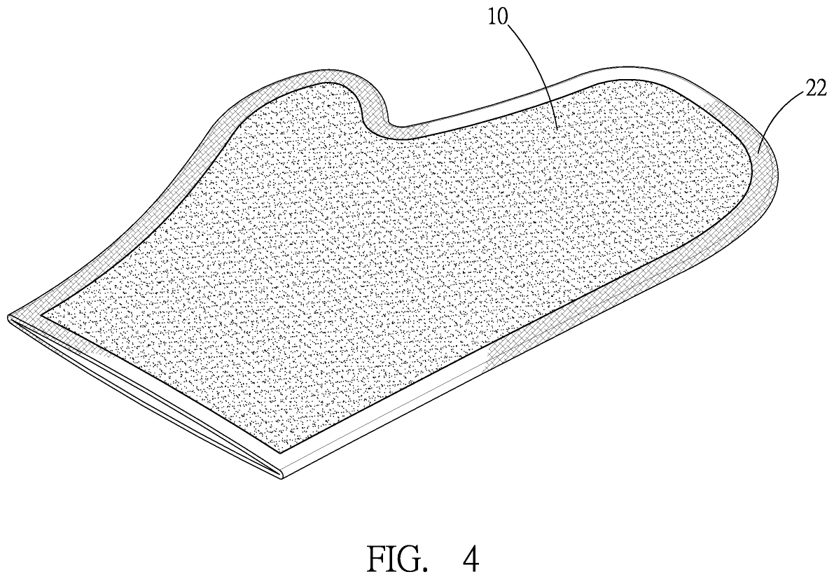

The mixture 10 of the present embodiment may be coated on a fiber cloth 21 (as shown in FIG. 3), a glove (as shown in FIG. 4) or any equivalent object. For example, the mixture 10 may coated on a paper (not shown), and the paper is rolled up like toilet paper for use.

The mixture 10 of the present embodiment may work without water. However, working with water or water with soap or detergent is suggested.

After use the mixture 10 of the present embodiment to clean, the mixture 10 may be washed by water to remove the particles attached on the mixture. As a result, the mixture 10 may repeatedly use for cleaning.

In conclusion, the mixture 10 of the present embodiment may easily remove the particles 80 from the surface of the article 90 by the stickiness and static electricity of the resin 12 and the “shovel” function of the abrasives 14, and then the wax 11 and the glycerin 13 may form a bright and smooth surface after the particles are removed to provide a cleaning and shiny surface.

It should be realized that the above description is only some preferred embodiments of the present invention and should not be deemed as limitations of implementing the present invention. All substantially equivalent variations and modifications which employ the concepts disclosed in this specification and the appended claims should fall within the scope of the present invention.

What is claimed is:

1. A mixture with a waxing and polishing effect, comprises:
A) 15-30% by weight of wax;
B) 25-45% by weight of colloidal resin;
C) 2-5% by weight of glycerin; and
D) 15-30% by weight % of abrasives.
wherein the glycerin in the mixture releases the wax evenly and slowly on a surface to provide function of glazing, water repellency and lubrication, the abrasives shovels particles on the surface up and the resin sticks the particle to form a bright and smooth surface.

2. The mixture of claim 1, wherein the resin is selected from the group consisting of silicone, medical white glue or melt glue.

3. The mixture of claim 1, wherein the abrasives are selected from the group consisting of aluminium oxide, silicon carbide, garnet, calcium carbonate, or alumina.

4. The mixture of claim 1, wherein the abrasives have different crystalized shapes.

5. The mixture of claim 1, wherein the abrasives have an average diameter less than 0.001 mm.

6. The mixture of claim 1, wherein the mixture is coated on a sponge or a foam.

7. The mixture of claim 1, wherein the mixture is coated on a fiber cloth.

8. The mixture of claim 1, wherein the mixture is coated on a paper.

9. The mixture of claim 1, wherein the mixture is coated on a glove.

10. The mixture of claim 1, wherein 2-5% by weight of the glycerin is replaced by dipropylene glycol or propylene glycol.
